(19) United States
(12) Patent Application Publication
(10) Pub. No.: US 2009/0179413 A1
(43) Pub. Date: Jul. 16, 2009

(54) Photo booklet kit and a method and a manufacturing device related thereto

(76) Inventor: Goran Tolf, Taby (SE)

Correspondence Address: COOPER & DUNHAM, LLP, 30 Rockefeller Plaza, 20th Floor, NEW YORK, NY, 10112, US

(21) Appl. No.: 12/009,110

(22) Filed: Jan. 16, 2008

(51) Int. Cl. B42D 1/08; B42D 1/00; B42C 9/00; B26B 3/00

(52) U.S. Cl. 281/22; 281/21.1; 412/8; 412/1

(57) ABSTRACT

The invention relates to a photo booklet kit. The kit includes at least one booklet cover and at least one bundle of papers. The papers are adapted for printing photos thereon and have a resolution of more than 100 DPI. The cover has a front sheet, a rear sheet and a spine therebetween that is separated from the front and rear sheets by a respective folding line. The spine has a meltable adhesive attached to its inside. The bundle of papers has papers of size that matches the booklet cover. The invention also relates to a method for manufacturing a bundle of papers adapted for use in the kit and to a knife adapted for cutting such a bundle.

### BACKGROUND

1. Field of the Invention

The present invention in a first aspect relates to a photo booklet kit.

In a second aspect, the invention relates to a method for manufacturing a bundle of papers, having a jagged binding edge, the binding edge being adapted to be glued to the spine of a booklet cover.

In a third aspect, the invention relates to a knife adapted for cutting a bundle of papers.

2. Background of the Invention

With the introduction of the digital camera and the explosive increase of photos taken by amateurs as a result thereof, new habits and needs regarding storing and presenting the photos have developed. This is today performed digitally and/or as printed photos. The present invention is directed to storing and presenting printed photos. Traditionally this has been done in photo albums. Often photo shops and providers of paper photos printed from digital photos deliver the photos in various kinds of ready made albums or booklets.

Today many amateur photographers have the necessary equipment themselves to make paper prints of their digital photos, and many people prefer this alternative. For many of them traditional photo albums are felt as outdated and do not correspond to their needs for storing and presenting printed photos. They might for example wish to have the photos stored in a theme-based entity. Higher flexibility and a higher possibility of a creative presentation of the photos are often desired.

The object of the present invention is to meet the demand in this respect.

### SUMMARY OF THE INVENTION

According to the first aspect of the invention this object is met by providing a booklet kit which includes at least one booklet cover and at least one bundle of papers adapted for printing photos thereon and having a resolution of more than 100 DIP (Dots Per Inch). The booklet cover has a front sheet, a rear sheet and a spine therebetween separated from the front and rear sheets by a respective folding line. The spine has a meltable adhesive string attached to its inside and the bundle of papers has papers of a size matching the booklet cover.

The kit provides a possibility to the amateur photographer to manufacture an attractive booklet for his photos in a very simple way.

Since the papers in the bundle have a relatively high resolution, the papers will ensure a good quality of the photos.

The only means necessary for manufacturing the booklet is a device that generates heat to the spine of the booklet cover to melt the adhesive such that the papers can be glued to the spine.

This technique is as such well known within the office area for producing printed publications.

According to a preferred embodiment the kit includes a plurality of booklet covers and a plurality of bundles such that a plurality of booklets can be made from the kit.

According to a further preferred embodiment some of the booklet covers are of different sizes, regarding the width of the spine.

This allows to make booklets containing different number of photos and thereby offers a higher degree of flexibility.

According to a further preferred embodiment the covers are of different sizes regarding the dimensions of the front and rear sheets and the bundles of papers are of correspondingly matching different sizes.

This gives the user a freedom to select a size of the booklet as desired, which further increases the flexibility and allows a higher degree of creativity for the user.

According to a further embodiment the kit further includes a bundle of envelopes, each envelope having a size adapted to house a booklet with photo papers attached to its spines.

In many cases the user might have interest to send photo booklets by ordinary mail to friends. This embodiment makes this easy.

According to a further embodiment the booklet covers have a pre-print on the front sheet and/or the rear sheet.

This makes the booklet more attractive in special cases, where the pre-print for example can contain a message like “Seasons Greetings” or “From our Wedding” and eventually a picture.

According to a further embodiment the booklet cover has a hole on the front sheet and/or the rear sheet.

Thereby the booklet will allow the first and/or the last photo therein to be visible from the outside. This might make the booklet more attractive and will make it easy to quickly identify its contents.

According to a further preferred embodiment the string of adhesive is covered by a woven net.

When a plurality of booklet covers are delivered or stored it is convenient to have them inserted in each other. This means that the outside of the spine of one cover abuts the adhesive string on the inside of the adjacent cover. Although the adhesive normally does not have an adhesive effect when not heated there cannot be completely excluded that adhesion will take place between the two adjacent covers. In particular there is a risk for that when one does not have control of how the booklets are stored. They might for example be exposed to sunshine. The woven net eliminates this risk.

According to a further preferred embodiment each paper has a binding edge which is jagged.

By providing the binding edge with a jagged edge profile the area of the edge is increased. By increasing the area that is exposed to the adhesive the binding will be stronger.

According to a further preferred embodiment the jagged edge is formed by depressions in the edge, which depressions have a depth in the range of 0.3 to 2.0 mm.

This is a suitable dimension of the profile depth with regards to the thickness of the adhesive string. Preferably the depth is in the range of 0.4 to 1.0 mm. The thickness of the adhesive string typically is about 0.8 mm.

According to a further preferred embodiment the teeth formed between the depressions have an extension in the direction of the binding edge that is longer than the extension of the depression in the same direction.

By such a relation the total surface exposed to the adhesive, i.e. the surface on the edge and the surfaces on both sides of the edge will be large resulting in a strong binding.

According to a further preferred embodiment the papers have a resolution of at least 300 DPI.

Thereby a booklet will be provided with high quality photos.

According to a further preferred embodiment the papers have an opacity that is at least 80%.

Thereby it is avoided that a photo can be viewed without influence of the photo nearest beneath. Also printing on the rear side can be accepted without disturbance. Preferably the opacity is at least 90%.

According to a further preferred embodiment the papers are adapted for printing on both sides.

Thereby the number of photos that can be contained in one booklet is doubled.

According to a further preferred embodiment the papers are of a type adapted for inkjet printing.

This provides the highest possible quality for the photo prints. A paper adapted for inkjet printing generally also has a relative high softness which enhances the adhesion to the adhesive string.

The above mentioned preferred embodiments of the invented photo booklet kit is set out below.

According to the second aspect of the invention the object is met in that a method of the kind in question includes the specific measures that the bundle of sheets is cut by a knife having a cutting edge that has a profiled shape in a section perpendicular to the cutting direction, the profile corresponding to the intended shape of the jagged binding edge when seen in a direction perpendicular to the paper surface.

By cutting the bundle of papers in this way the papers will receive the suitable jagged binding edge in a simple manner allowing low production costs.

According to the third aspect of the invention the knife for cutting a bundle of papers has the specific feature that the cutting edge is toothed profiled in the xy-plane along its longitudinal extension for providing a toothed cut. The xy-plane is defined in that the longitudinal extension of the knife is in the x-direction, its width is in the y-direction and its height is in the z-direction.

With the invented knife a bundle of papers with jagged binding edges can be manufactured easily and efficiently.

According to a preferred embodiment of the invented knife the width of the profile in the y-direction is in the range of 0.3 to 2.0 mm.

With these dimension the knife will provide binding edges on the papers that are suitable for the binding to the spine of the booklet.

According to a further preferred embodiment each tooth in the x-direction is shorter than the interspace between two adjacent teeth.

This results in a profile of the binding edge according to a preferred embodiment of the invented kit and results in the corresponding advantages, which are mentioned above in connection with that embodiment.

According to a further preferred embodiment the teeth form an angle with the z-direction.

Thereby the knife will cut the bundle gradually along the binding edges of the papers therein. This results in that a lower cutting force is required in comparison with a simultaneous cutting along the binding edge.

The above mentioned preferred embodiments of the invented knife are set out below.

The invention will be further explained through following detailed description of examples thereof.

### BRIEF DESCRIPTION OF THE DRAWINGS

FIG. 1 is a prospective view of a booklet cover in a kit according to the invention.

FIG. 2 is an enlarged section through the spine of the booklet cover in FIG. 1.

FIG. 3 is a perspective view of a bundle of papers in a kit according to the invention.

FIG. 4 is an enlarged side view on a part of the binding edge of a paper in the bundle of FIG. 3.

FIG. 5 is an illustration of a kit having units of various sizes.

FIG. 6 is a perspective view of a bundle of envelopes in a kit according to the invention.

FIG. 7 is a longitudinal section through a knife according to the invention.

FIG. 8 is a side view of the knife in FIG. 7.

### DETAILED DESCRIPTION OF EXAMPLES

FIG. 1 in a perspective view illustrates a booklet cover 1 forming a part of a photo kit according to the invention. The cover 1 has a front sheet 11, a rear sheet 12 and a spine 13 therebetween. A folding line 14 on each side of the spine separates the spine 13 from the front sheet 11 and the rear sheet 12 respectively. The front sheet has a rectangular hole 15. On the front sheet is printed a message and an illustration. The cover can for example have the size of somewhat larger than 4×6 inches for binding papers of that size. The width of the spine is typically 3 mm, which is suitable if the booklet is intended to contain 12 pages.

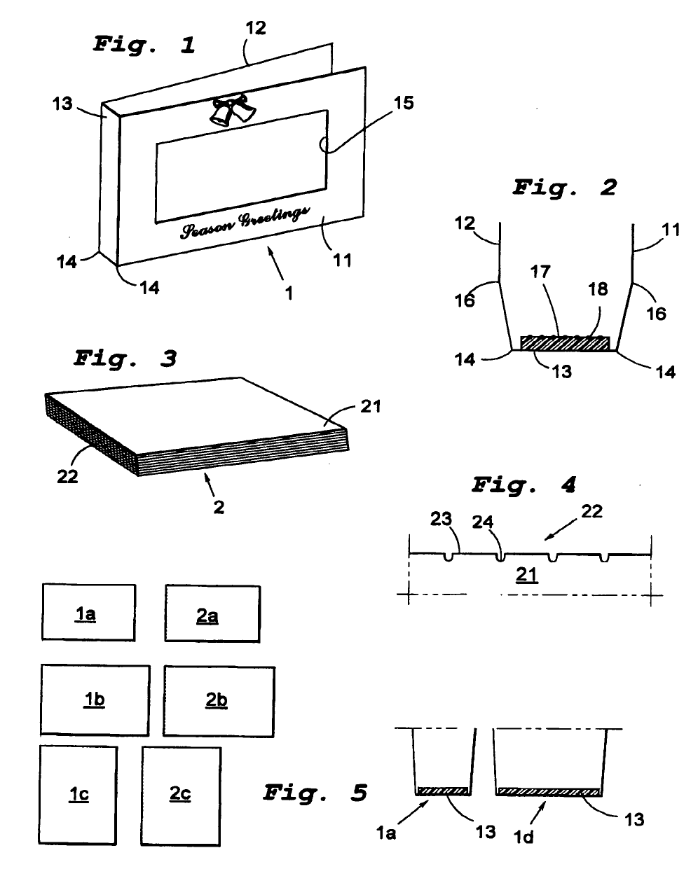

FIG. 2 is an enlarged section through the spine in the cover of FIG. 1. In addition to the folding lines 14 separating the front and rear sheets from the spine a second folding line 14 adjacent the spine.

On the inside of the spine 13 an adhesive 17 is attached. The adhesive can be a glue and is of the type that is inactive, i.e. in solid state at room temperature.

The adhesive can be activated by heat such that it melts to a gel state.

On the top of the adhesive 17 a coarse woven net 18 is attached such that the net 18 is partly embedded in the adhesive and partly projects outside its surface.

FIG. 3 is a perspective view illustrating a bundle 2 of papers 21 forming a part of the photo kit, and being intended to be inserted into the booklet cover 1 and attached to the spine 13 thereof after having received photo prints.

The papers 21 are of a type suitable for printing photos thereon. The resolution therefore is higher than 100 DPI, preferably higher than 300 DPI. The opacity is higher than 80% and preferably at least 90%. The papers are adapted for printing on both sides.

The papers have a coating on each side such that it quickly absorbs ink, so that the paper is suitable for inkjet printing. Mat paper is preferred, and typically 130 g paper is used.

One edge of each paper 21 in the bundle 2 is a binding edge 22. This edge has a jagged profile. In FIG. 4 a part of the binding edge is illustrated in an enlarged scale. The jagged edge is formed by depressions 24 forming teeth 23 therebetween. The depth of the depressions is in the range of 0.3 to 2.0 mm and preferably in the range of 0.4 to 1.0 mm. Typically the depth of 0.6 mm and the width is about the same. Each tooth 23 typically has a length of about 3 mm.

Making a booklet from the kit is accomplished in the following way. First each paper is provided with a photo print on one or both of its sides. Thereafter the printed photos are to be attached to the cover. This is made by placing the outside of the spine 13 to a heating surface such that the adhesive 17 melts to a gel state. A heating device specially designed for this purpose can be used for that.

When the adhesive is heated the bundle of papers is inserted into cover 1 such that the binding edge 22 of each paper abuts the surface of the gelled adhesive 17. Then a slight pressure is applied to the bundle, whereby the binding edge 22 of the papers will penetrate into the adhesive 17 until they reach the spine 13. Thereafter the adhesive will be allowed to cool down, whereby it becomes rigid and the papers are attached. When the binding edges 22 are pressed down through the adhesive 17 they will press the woven net 18 down against the spine 13.

A photo kit according to the invention may contain a plurality of booklet covers of different sizes and a plurality of bundles of papers of corresponding sizes. The kit illustrated in FIG. 5 has covers la of the size 4×6 inches, laying covers 1b of the size 5×7 inches and standing covers 1c of the size 5×7 inches. The 4×6 covers are of two thicknesses, cover 1a having a spine width of 3 mm and the cover 1b having a spine width of 6 mm.

FIG. 6 illustrates a bundle of envelopes 3 that also can be included in a kit according to the invention. Each envelope has a size adapted for containing a booklet cover with photos.

Thus, it is to be understood that the content of a kit according to the invention can vary widely. The kit may for example consist of 10 booklet covers with 3 mm spine with one bundle of 120 papers or 5 booklet covers with 6 mm spine and 120 papers or 12 booklet covers with 1.5 mm spine, a bundle of 75 papers and 12 envelopes etc. The booklet covers of course can be of any size, i.e. letter size.

FIG. 3 shows a bundle of papers 21. The bundle is cut by a knife, having a profile that creates the jagged binding edge 22 on the papers in the bundle.

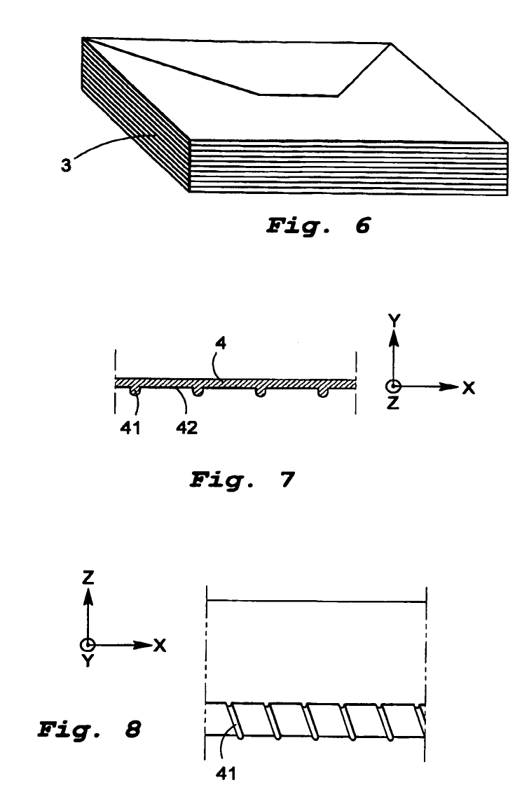

FIG. 7 illustrates the knife 4 in an enlarged partial section through the cutting edge thereof. The cutting edge is shown in a coordinate system such that the longitudinal direction of the cutting edge 4 is in the x-direction, its width in the y-direction and its height in the z-direction. The cutting edge 4 is profiled with a toothed profile having teeth 41 projecting from a straight line 42. The profile is such that a cut corresponding to FIG. 4 is obtained. The width of the profile in the y-direction is in the range of 0.3 to 2.0 mm. The teeth 41 shown extend 0.6 mm in the y-direction and 0.6 mm in the x-direction, whereas the interspace between two teeth is about 3 mm.

FIG. 8 illustrates the knife in a side view as seen in the y-direction. As can be seen the teeth form an angle with the z-direction. The angle is in the range of 5° to 40°, preferably in the range of 15° to 25°. In the figure the angle is about 20°. When cutting the bundle of papers the longitudinal extension of the cutting edge of the knife is inclined in relation to the planes of the papers in the bundle in order to achieve a gradual cutting of the pare. The purpose of the included teeth 41 is to compensate for this inclination so that each tooth will move perpendicular to the papers when cutting.

What is claimed is:

1. A photo booklet kit, wherein the kit includes a least one booklet cover and at least one bundle of papers adapted for printing photos thereon and having a resolution of more than 100 DPI, the booklet cover having a front sheet, a rear sheet and a spine therebetween separated from the front and rear sheets by a respective folding line, the space having a meltable adhesive attached to its inside, the bundle of papers having papers of size matching the booklet cover.

2. A kit according to claim 1, wherein the kit includes a plurality of booklet covers and a plurality of bundles.

3. A kit according to claim 2, wherein at least some of the booklet covers are of different sizes, regarding the width of the spine.

4. A kit according to claim 2, wherein at least some of the covers are of different sizes regarding the dimensions of the front and rear sheets and wherein the bundles of papers are of correspondingly matching different sizes.

5. A kit according to claim 1, wherein the kit further includes a bundle of envelopes, each envelope having a size adapted to house a booklet with photo papers attached to its spine.

6. A kit according to claim 1, wherein the at least one of the booklet covers has a pre-print on the front sheets and/or the rear sheet.

7. A kit according to claim 1, wherein at least one of the booklet covers has a hole on the front sheet and/or the rear sheet.

8. A kit according to claim 1, wherein the adhesive is covered by a woven net.

9. A kit according to claim 1, wherein each paper has a binding edge, said binding edge being jagged.

10. A kit according to claim 9, wherein the jagged edge is formed by depressions in the edge, the depressions having a depth in the range of 0.3 to 2.0 mm.

11. A kit according to claim 10, wherein the teeth formed between the depressions have an extension in the direction of the binding edge, that is longer that the extension of the depressions in the same direction.

12. A kit according to claim 1, wherein the papers have a resolution of at least 300 DPI.

13. A kit according to claim 1, wherein the papers have an opacity that is at least 80%.

14. A kit according to claim 1, wherein the papers are adapted for printing photos on each side.

15. A kit according to claim 1, wherein the papers are of a type adapted for inkjet printing.

16. A method for manufacturing a bundle of papers having a jagged binding edge, the binding edge being adapted to be glued to the spine of a booklet cover, comprising providing a bundle of sheets and cutting the bundle of sheets by a knife having a cutting edge that has a profiled shape in a section perpendicular to the cutting direction, the profile corresponding to the intended shape of the jagged binding edge when seen in a direction perpendicular to the paper surface.

17. A knife adapted for cutting a bundle of papers, the knife in an orthogonal xyz-system having a longitudinal extension in the x-direction, a width in the y-direction and a height in the z-direction, wherein the cutting edge is toothed profiled in the xy-plane along its longitudinal extension for providing a toothed cut.

18. A knife according to claim 17, wherein the width of the profile in the y-direction is in the range of 0.3 to 2.0 mm.

19. A knife according to claim 18, wherein each tooth in the x-direction is shorter than the interspace between two adjacent teeth.

20. A knife according to claim 17, wherein the teeth form an angle with the z-direction.
